(19) United States
(12) Patent Application Publication
(10) Pub. No.: US 2004/0192282 A1
(43) Pub. Date: Sep. 30, 2004

(54) Mobile telephony application platform

(76) Inventor: Vinod Vasudevan, Powai Mumbai (IN)

Correspondence Address: STEPTOE & JOHNSON LLP, Attn: Stuart T. F. Huang - BOX USPTO, 1330 Connecticut Avenue, NW, Washington, DC, 20036, US

(21) Appl. No.: 10/772,232

(22) Filed: Feb. 4, 2004

Related U.S. Application Data
(60) Provisional application No. 60/444,645, filed on Feb. 4, 2003.

(51) Int. Cl. H04M 3/00

(52) U.S. Cl. 455/419; 455/412.1

(57) ABSTRACT

A cellular telephone system and method for using low-cost low-memory cellular handsets is disclosed. The system and method allow for cellular telephony with inexpensive “dumb” cellular telephones that request code, data, and processing power from an application platform. The application platform is also capable of pushing code, data and processing power to the cellular telephones.

### BACKGROUND OF THE INVENTION

1. Field of the Invention

The invention relates to a system and method for providing information services to mobile handsets. More particularly, the invention relates to a system and method of providing service to mobile telephones that may have limited or varying on-board resources.

2. Discussion of Background Information

A need exists for enhancing information services provided to mobile handsets. Information service are services other than point-to-point telephone (voice) services, and may include, for example, reception of news, stock quotes, or other information, access to games or other entertainment content, and computational capability, such as spread sheet manipulation. A system of mobile handsets, such as a cellular telephone network, may have varying models of handsets with varying on-board memory and on-board processing capability. It is desirable to make available to users diverse levels of service options, including options requiring relatively high processing and memory resources, even though users' handset capabilities may vary.

### SUMMARY OF THE INVENTION

According to one embodiment of the present invention, an Application Platform (AP) is provided on a communication network. The application platform may communicate with mobile handsets. Handsets may utilize memory and processing resources of the AP.

A User Storage Manager (USM) at the AP manages allocation of storage of AP resources for specific a specific user (and the user's associated handset) in cooperation with a local resource manager at the handset. The USM process executes at the server side of the AP. The USM receives requests for user specific storage from the local resource manager. The USM allocates AP storage capacity to specific (mobile) users and informs the local resources manager. The USM handles write and read requests from the local resource manager and writes/reads data into/from user specific storage. User specific storage is used for storing stateful data, i.e., data that is dependent on the specific user and associated services. The USM also verifies a users continued access rights and space rights.

According to another embodiment of the present invention, a Common Storage Manager (CSM) is presented. The CSM maintains storage for stateless data that is common access for all users. This common data may be “code” for execution on a handset in connection with particular services. It may also include “contact” parts that do not vary from user to user. The CSM receives “read” requests from local resource managers, and verifies continued access rights.

According to another embodiment of the present invention, a Processor Manager (PM) is provided at the AP. The PM handles the allocation of execution time computational resources for each user. The PM directs computational or service request from a local resource manager. Depending on the type of request, type of user device and type of user (e.g., basic or premium subscription), the PM will allocate an appropriate computing resource at the server. The computing resource consists typically of a process which determines the “CPU” and “RAM” usage allocated at an AP server. A table lookup or an algorithmic decision or a combination of both at least partially determines the appropriate process. The allocation of resources may be determined at least in part by selection of one of multiple versions of executable code downloaded from the AP to a handset.

According to another embodiment of the present invention, a Bootstrap Processor is presented at mobile handsets. The Bootstrap Processor (BS) controls start up of a handset and initiates information services. The BS sends registration requests to the AP server side and registers the user with the server. In response, a processor manager at the AP makes available an appropriate local resource manager and an appropriate user interface manager. The local resource manager is sent to the device and executes primarily on the device. The local resource manage and user interface manager may have a state that is specific to the particular user, such as state information about the level of service available to the handset. The User Interface Manager (UIM) is a process executing on the AP server side that determines the amount of AP CPU and RAM allocated to the local resource manager of the particular user. This completes the registration process done by the BP and establishes the device with access to AP server computational power (CPU) and memory (RAM).

According to another embodiment of the present invention, a Local Resource Manager (LRM) is presented at the handset. The LRM allocates all the resources on mobile device and cooperates with the User Storage Manager, Common Storage Manager and Processor Manager at the AP. The LRM sends a request for user specific storage to the user storage manager. The LRM sends read and write requests to the AP for reading and writing user specific data. The LRM also sends read requests for common data to the AP common storage manager. The LRM sends service requests to the AP PM, which results in allocation of CPU and RAM at the server side. The LRM interacts with the user interface manager for presentation of appropriate User Interface elements to the user. The LRM may also invoke a Multi-Lingual Processor for displaying multi lingual data.

Other exemplary embodiments and advantages of the present invention may be ascertained by reviewing the present disclosure and the accompanying drawings.

### BRIEF DESCRIPTION OF THE DRAWINGS

The present invention is further described in the detailed description which follows, in reference to the noted plurality of drawings by way of non-limiting examples of certain embodiments of the present invention, in which like numerals represent like elements throughout the several views of the drawings, and wherein:

FIG. 1 is a schematic diagram that provides an overview of an embodiment of a communication system having an Application Platform;

FIG. 2 is a schematic diagram of an Application Platform;

FIG. 3 is schematic diagram of an Application Platform depicting certain features that follow user registration;

FIG. 4 is a schematic diagram of an Application Platform depicting certain features pertinent to service selection;

FIG. 5 is a schematic diagram of a Discovery Application Server;

FIG. 6 is an illustration of a cellular telephone user interface;

FIG. 7 is a memory map of a cellular telephone;

FIG. 8. is a flowchart illustrating a Bootstrap Process;

FIG. 9 is a flowchart illustrating a server-side menu push to a client;

FIG. 10 is a flowchart illustrating a client-side service request;

FIG. 11 is a flowchart illustrating a server-side code and data push to a client;

FIG. 12 is a flowchart illustrating a client-side multilingual display process;

FIG. 13 is a flowchart illustrating a server-side storage of client overflow code and data; and

FIG. 14 is a flowchart illustrating a server-side calculation for a client process.

### DETAILED DESCRIPTION OF THE EXEMPLARY EMBODIMENT

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

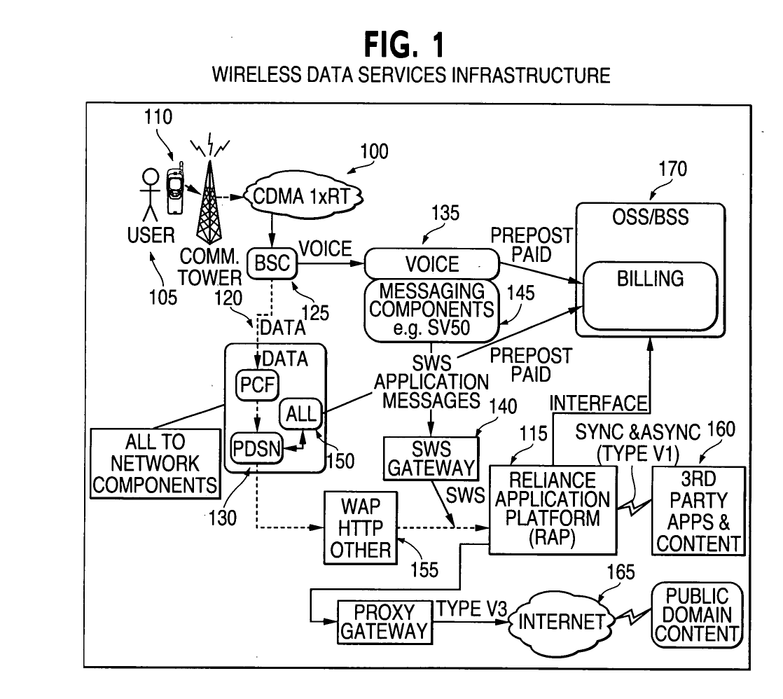

FIG. 1 illustrates a communication system. Components include a channel 100 and a population of users 105. Channel 100 may be a Code Division Multiple Access (CDMA) 1xRT (wireless) system. Each user 105 has a mobile communication device 110, such as cell phone, personal digital assistant (PDA), or other device capable of communication through the channel 100.

An Application Platform (AP) 115 communicates through the channel 100 with user devices 110. Some forms of transmission, such as data 120, may pass from users to AP 115 via a base station controller (BSC) 125 and a data network. Other forms of data, such as short message service (SMS) 145 or voice communications 135 may pass from users 105 to AP 115 via SMS gateway 140.

A packet data-serving node (PDSN) 130 establishes, maintains and terminates the link layer to mobile devices 110, preferably at the network level. PDSN 130 also initiates authentication, authorization and accounting (AAA) 150. Once traffic is authorized, PDSN 150 routes it on an IP network to an application-protocol aware gateway 155, which in turn will route traffic to the AP 115. PDSN 150 may also collect usage data for accounting purposes.

AP 115 also links to external service providers 160 and other sources of content, such as the internet 165. An operations support system/business support system (OSS/BSS) billing engine 170 associated with AP 115 maintains accounts for services rendered over channel 100.

In general operation, user devices 110 communicate through channel 100 to AP 115, and vice versa. User devices 110 may initiate communication to AP 115 in response to manipulation by human operator 105. Some processes within user device 110 might initiate communication without operator initiation. AP 115 may also initiate communication to handset 110. The AP may serve as a gateway through with the users 105 may access information services from external service providers 160 and other sources of content, such as the internet 165.

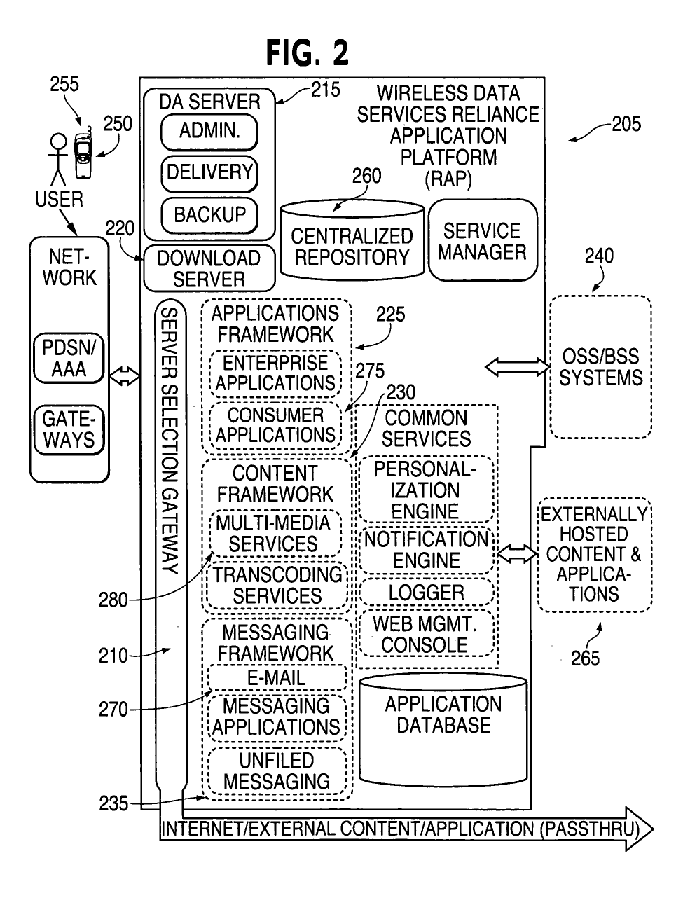

FIG. 2 illustrates an AP 205 and other representative elements from FIG. 1. AP 205 includes a Service Selection Gateway (SSG) 210, a Discovery Application Server (DA Server) 215, a Download Server 220, a plurality of framework components (e.g., Applications Framework component 225, Content Framework component 230, and messaging Framework component 235), and application servers. It also has interfaces to various Intelligent Business Systems (IBS) (e.g., OSS/BSS 240) components for customer care, billing and other system management activities.

After initiation, most communications from user device 250 to AP 205 will be for initiating, using, or terminating an information service. SSG 210 acts as a point of “allow” or “deny” for service requests. SSG 210 will determine whether or not a particular user 255 has permission to access a requested service by referencing information about the user in a Centralized Repository 260. The Centralized Repository 260 is a database containing all AP-common parameters along with application specific parameters. If the information service is hosted by the AP, SSG 210 may check subscriber profiles held within Centralized Repository 260. If the service is hosted externally, SSG 210 may also communicate with the external host 265. Elements of AP 205 will maintain the AP-common parameters. Various applications maintain application preferences. Applications may be any service available to users, and application preferences may be any parameter associated therewith. For example, a user will typically select a set of services when he/she first obtains a device. The identities of the initially-selected services and locations where such services can be obtained are stored in Centralized Repository 260. Once a service request is authorized, SSG 210 will route service-related communications from a user to an interface for the service.

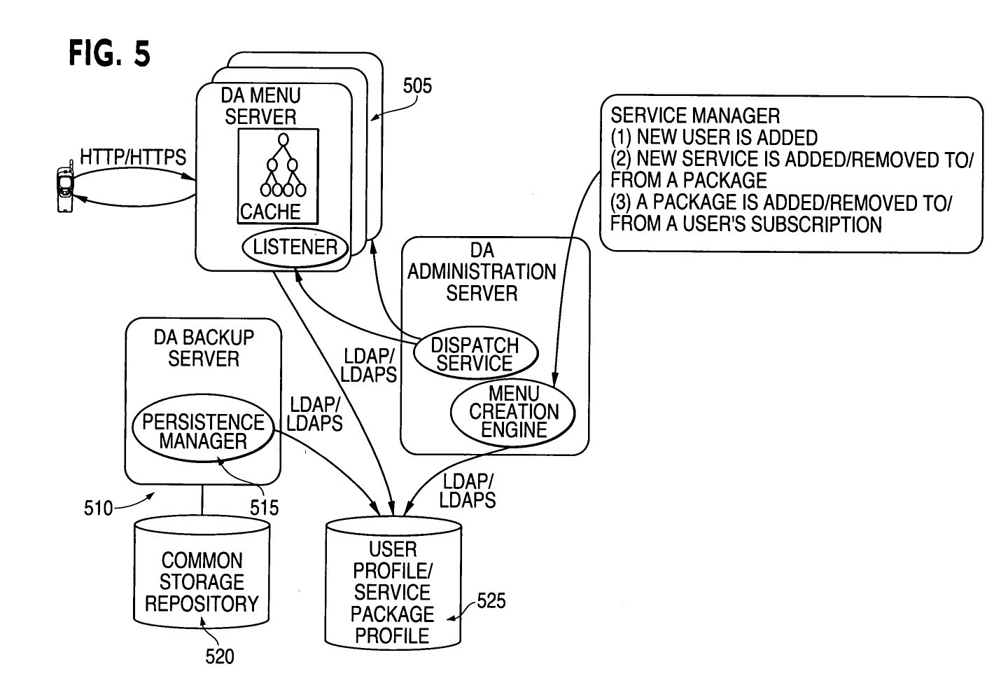

SSG 210 also handles interactions of the mobile client applications with the related service components and eventually triggers the termination of data services. (Mobile client applications may be application-specific processes, such as software, pushed to handset for a specific service, while service components are application-specific processes resident on the AP or external host.) Once “allowed,” a service request travels either to an AP framework (e.g., 225, 230, 235) or to an external content provider 265. An AP framework is a service hosted by the AP, such as email 270 or AP-provided multi-media content-distribution service 280. Once SSG 210 has identified and authorized a request, it is directed to Infotainment (e.g., through multi-media framework component 280), Messaging (e.g., through email framework component 270), Transactions (e.g., through consumer applications framework component 275), Web infrastructure, and other service components. A common repository (520 of FIG. 5) facilitates communications among different systems.

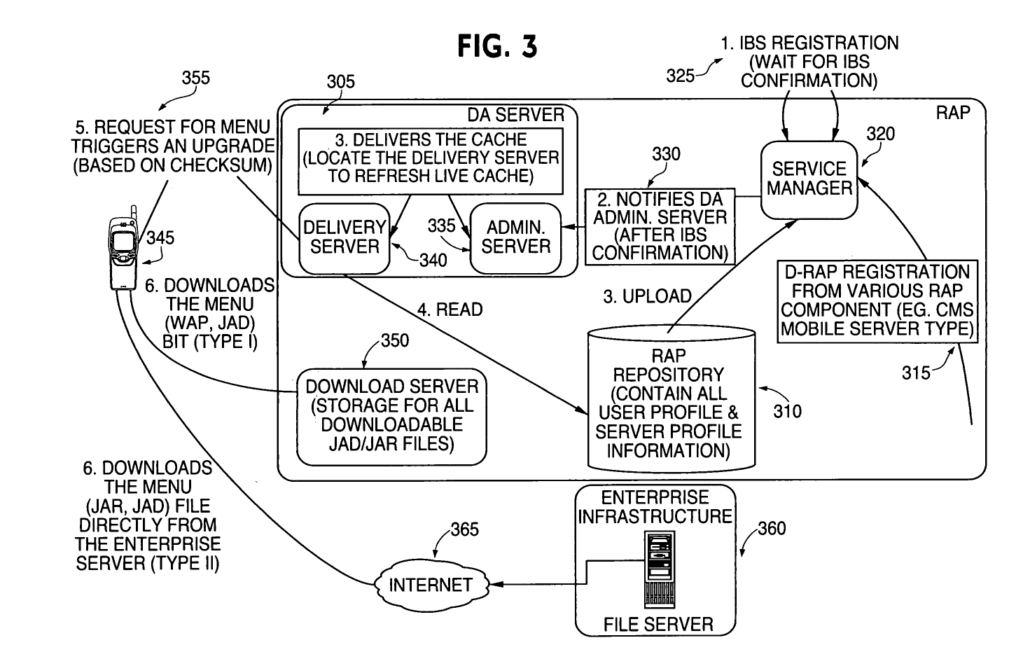

FIG. 3 depicts an AP provisioning a mobile device following user registration e.g., downloading capability enhancements beyond those resident in the mobile device's memory. When a user device 345 becomes active (such as upon first use or after power-up) it has limited functionality stored in permanent memory. User device 345 sends a session-initiate request to the AP. Such an initiation request is routed to DA Server 305. DA Server 305 will verify the services available to this user by checking the Centralized Repository 310, and respond to the session initiate with a list of available user services.

In general, the registration process starts with AP registration 315. From there, service manager 320 checks IBS registration 325. Once Service Manager 320 performs IBS confirmation 330, DA server 305 causes administration server 335 to force delivery server 340 to empty the user device cache. User device 345 requests a menu, which triggers an upgrade 355 using a checksum mechanism. User device 345 may download a midlet (e.g., JAR, JAD file) from download server, or may download the midlet directly from an enterprise server 360 connected through the internet 365.

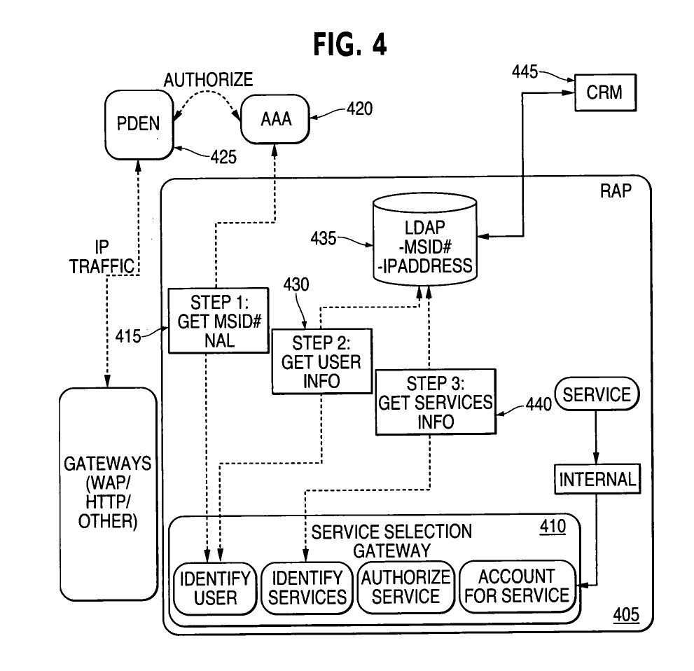

FIG. 4 is a schematic diagram of an AP depicting certain features pertinent to service selection. Service Selection gateway (SSG) 410, residing in AP 405, first identifies 415 the user device by requesting a device ID (e.g., MSID). After authentication, authorization, and accounting (AAA) 420 via PDSN 425, SSG 410 proceeds 430 to get user information through lightweight directory access protocol (LDAP) 435 from customer relationship manager (CRM) 445. SSG 410 also receives 440 service selection information via LDAP in order to determine services available to the user.

Services are grouped in part according to groupings of users. For instance, all users for a particular group might have access to a time sheet application. Users of another group might have access to a sales force automation service and a billing application service. A package of services for all users of a particular group is activated, which allows the DA server to download a customized menu to the user handset, etc.

The Discovery Application Administration Server (335 of FIG. 3) generates groupings of services for a particular mobile device depending upon which group (package) the subscriber has subscribed to, the language preference, and the type of device being used. That is, the DA Administration Server selects a package of client processes (software) to be downloaded to a user handset. These groupings take into account the location of the device client application (assuming this particular service requires a device application), and any language-specific characteristics of the device. The AP communicates this list to the device for display to the user. The location of the device client application refers to the location from which the device client application and related components can be retrieved so that they can be sent back to the mobile device which had explicitly requested for it. The DA Administration Server gets the location information from the Centralized Repository, which contains all the application-platform-common parameters like subscriber information, service information and package information that allow for extracting details pertaining to the subscription.

FIG. 5 depicts a DA. DA menu server 505 prepares and serves menus to user devices according to the user's associated package of services as retrieved from user profile storage 525. The DA server architecture includes DA Administration Server and DA Menu Server 505. Preferably, the DA server caches as much as possible to optimize server response time, while avoiding caching duplicative material.

The DA Server may download additional executable application clients for the corresponding services to the user. Once a service is made available to a user, the DA Server may potentially “push” a mobile client version to the phone. The mobile client application may be pushed down to the mobile device if the client does not already exist on the mobile device. The DA Server may also push an updated version of the mobile application client.

If the user device does not have sufficient memory to store a newly-requested application service, the least-recently used code or data of the user device is uploaded to the Discovery Application Backup Server 510 for storage. Suppose, by way of non-limiting example, a user has client applications for five services, requests a sixth, but lacks open handset memory. Suppose also that the user had used four of the five resources within the prior 24 hours, but had not use the fifth for several days. The Local Resource Manager would upload the state of the client for the fifth service to the AP, and overwrite its application client. When the user next requests the fifth service, his device will cooperate with the persistence manager 515 to download the client and restore the state of that service on his device.

Thus, the DA Server will control all initiation of OTA (Over-the-Air) downloads for services that require pushing applications to mobile devices. Once the desired client application is selected, the client application associated with the requested service will be downloaded over-the-air to the mobile device from the Download Server. Upon successful download, the mobile client application is ready for use.

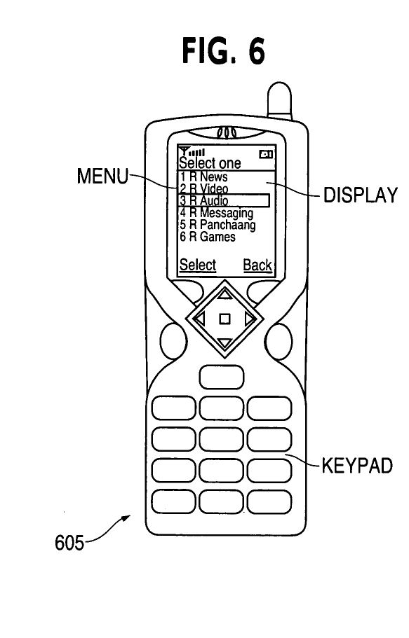

FIG. 6 depicts a user interface of a user device 605. User device 605 includes a screen capable of displaying a menu of services and a keypad for entering information.

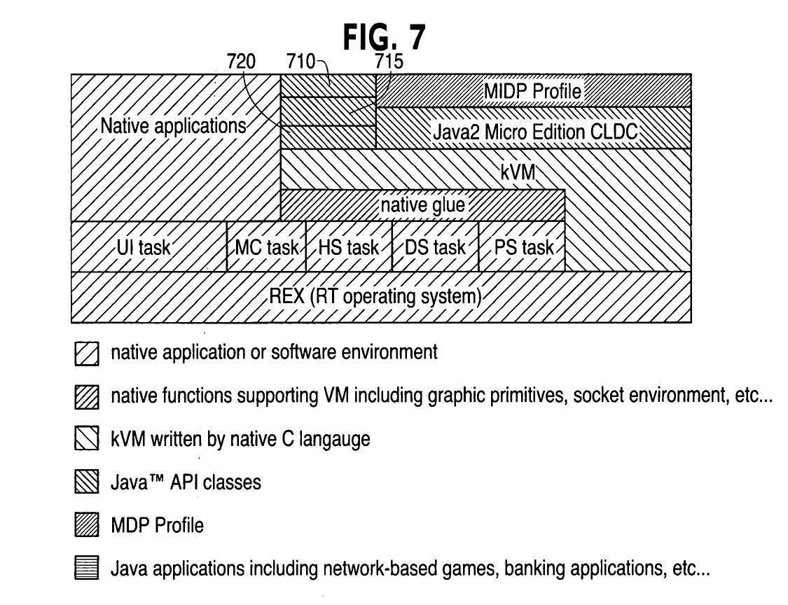

FIG. 7 is a memory map of a user device. Along with native applications 705 of the user device (e.g. for providing cellular voice communications) are bootstrap process memory section 710 (the bootstrap extension), multilingual memory section 715 (the multilingual extension), and other extensions 720 (e.g., user interface, networking, etc.). Local Resource Manager and client applications well reside in these areas. Also included are memory sections for: MDP profile, a Java2 Micro Edition CLDC, a kVM (kjava virtual machine), user interface tasks, MC tasks, HS tasks, DS tasks, PS tasks, REX (an operating system), and native glue, for binding together the various processes and memory storage sections.

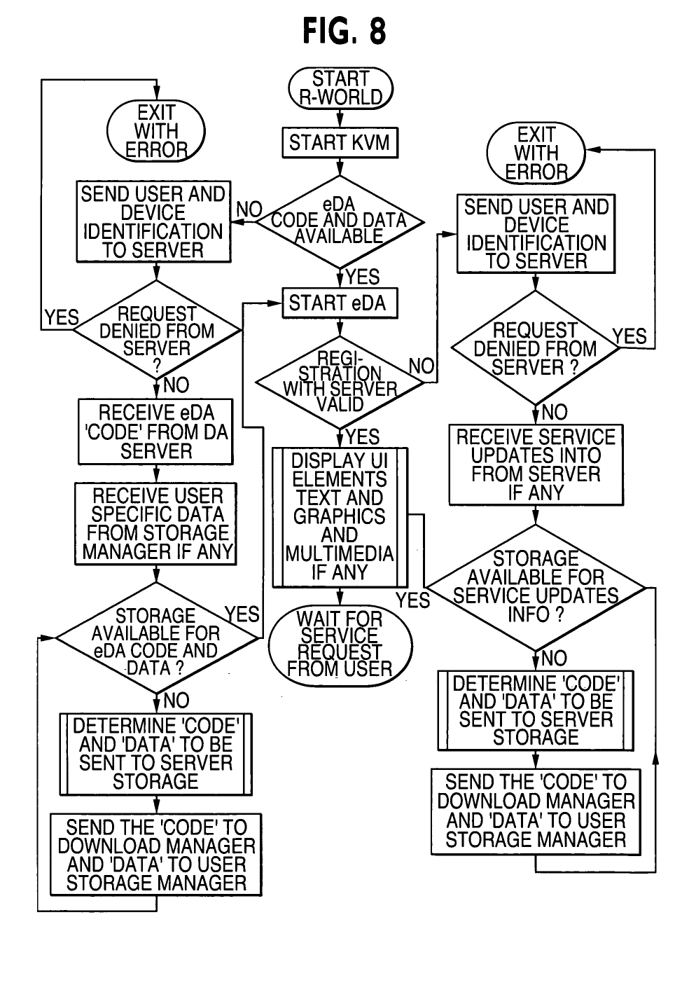

FIG. 8 is a flowchart illustrating a user device bootstrap process. The kJava virtual machine is activated upon startup. The user device system then checks whether an extended discovery application (eDA) is resident on the user device. The eDA is a set of processes that permits the user device to communicate with the AP, download menus service client applications, multilingual extensions, state data and other extensions. If the eDA is absent, the system sends a user device identification to the DA server. If the server accepts the request, it pushes eDA code (e.g., executables) and user-specific data (e.g., parameters) to the user device. Before doing so, however, the system checks whether the user device has sufficient storage capacity for the code and data, and if not, uploads the least-recently used code to the DA download manager and/or the least-recently used data to the user storage manager. Once the user device has successfully stored the eDA code and data, the eDA is started, and the system checks whether the device's registration is valid. If the registration is invalid, the user device forwards a request containing user and device identification to the server. The server acknowledges a user device request (if valid) and pushes available service updates to the user device, uploading user device memory overflow for storage if required. Once the user device is outfitted with an active eDA and its registration is validated, it displays user-appropriate user interface features, text, graphics, and multimedia options, if any. The user device is then ready to receive a service request from a user.

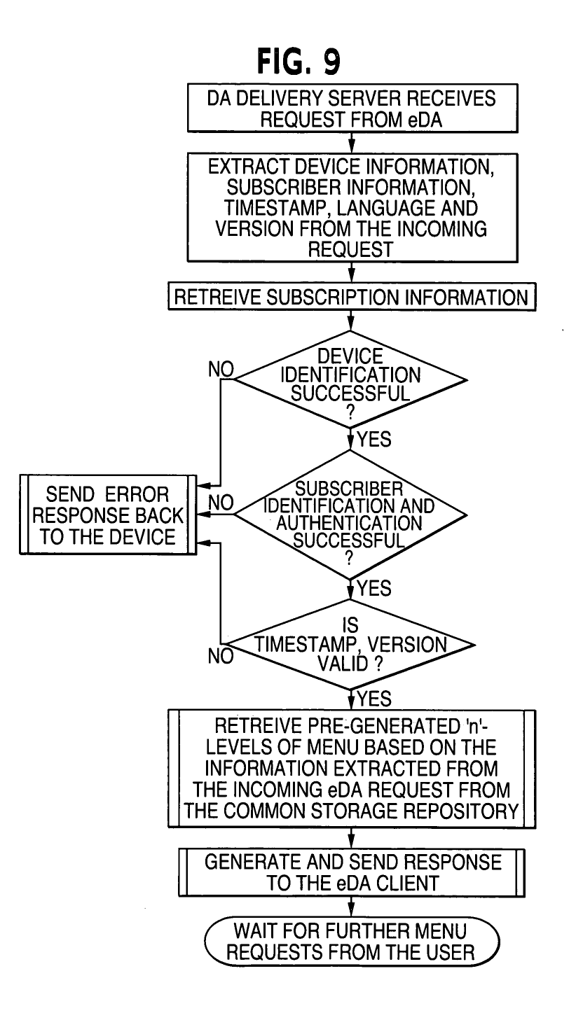

FIG. 9 is a flowchart illustrating a server-side menu push to a client. Upon successful server verification of a user device's registration (see FIG. 8), the eDA in the user device sends a formatted request to the DA Delivery Server. The server extracts device information, subscriber information, a timestamp, language information, and version parameters from the incoming request, and retrieves associated subscription information (e.g., package information). The server engages in a three-step AAA validation as follows. First, the server checks for successful device identification. Second, the subscriber identification and authentication are verified. Third, the timestamp and version are checked for validity. If any of these three validations fail, the server sends an error response back to the user device. If all three validations pass, the server retrieves from the Common Storage Repository (520 of FIG. 5) a pre-generated n-level menu to the user device based upon the information extracted from the incoming eDA request. The server pushes this menu to the user device eDA client, which awaits a user menu selection.

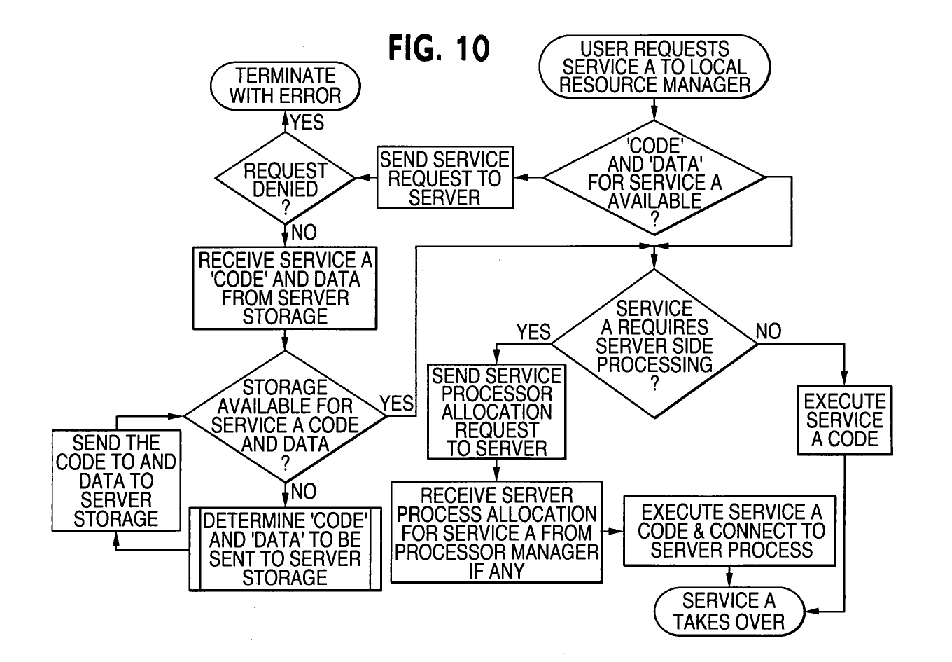

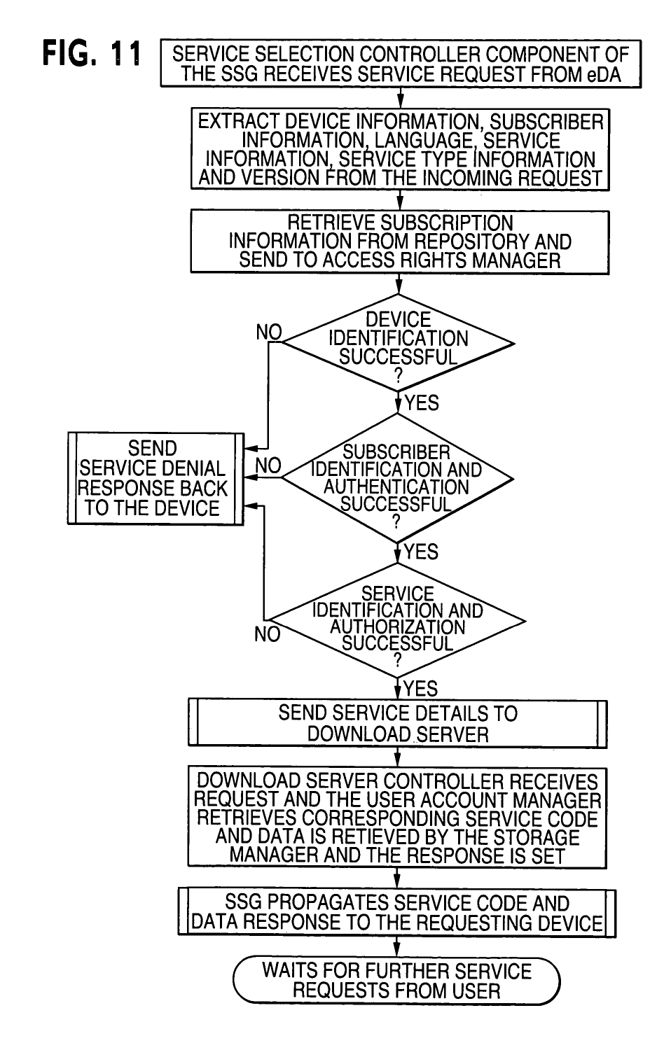

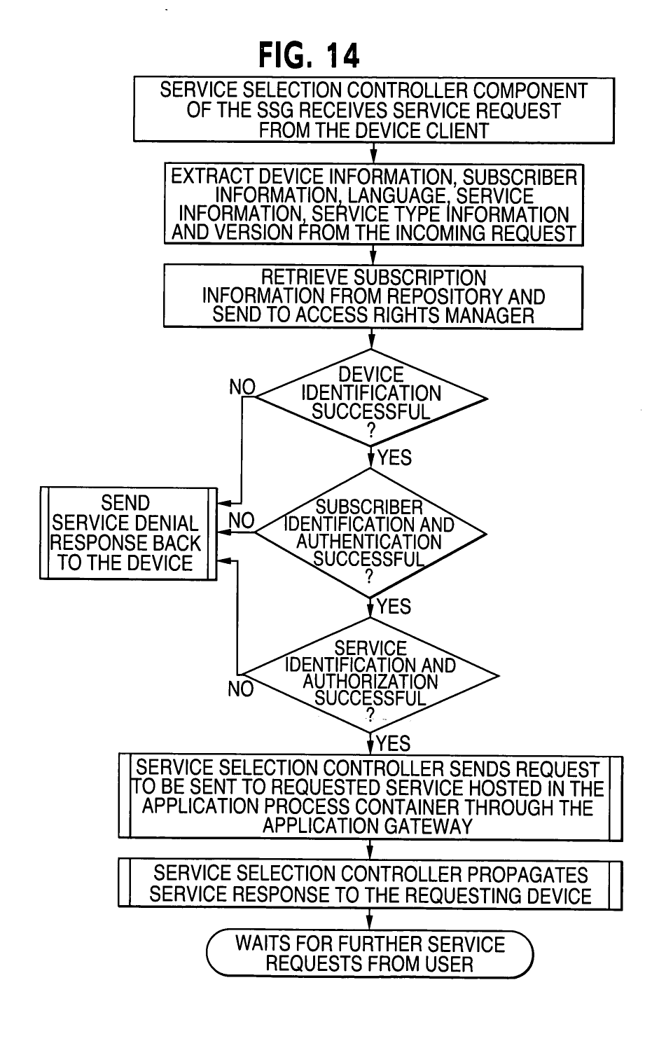

FIG. 10 is a flowchart illustrating a client-side service request. The process begins when a user selects a service (e.g., service “A”) on the user device. The request is received by a local resource manager resident on the user device. If the code and data for service A are not present at the user device, it sends a service request to the DA server. The DA server, upon accepting the request, sends the appropriate code and data to the user device, uploading user device code and data memory overflow to the DA backup server if required. (The server process of receiving and handling a client request for code and data are described further below in reference to FIG. 11.) Once the user device has acquired the appropriate code and data, it determines whether server-side processing is required to perform service A. If the user device is capable of executing the code for service A, it does so, handing off control to the service A code. If the user device does not have sufficient resources to run the service A code, it sends a server processor allocation request to the server (described in detail below in reference to FIG. 14). The server processor manager handles the request and executes the service A code remotely at the server, providing any required results to the user device. Processor and memory allocation between the user device and the RA may be negotiated between the application client and the RA. Alternately, it may be inherent in a version of client application selected for download. For example, the RA may push one version of an application client to a device having a relatively low processing capability, while the RA may push a different version of the same application client to another device having greater capability.

FIG. 11 is a flowchart illustrating a server-side code and data push to a client (i.e., a user device). When a client requires code and data for a particular service, it sends a request to the Service Selection Controller (SSC) component resident on the SSG (see FIG. 2). The SSC extracts device information, subscriber information, language, service information, service type information (e.g., allowed service packages), and version parameters from the incoming request. The SSC retrieves subscription information associated with the extracted information from a repository and forwards it to an Access Rights Manager. The server then passes the process to the three-step AAA validation as described above in reference to FIG. 9. Having passed the AAA validation, the server forwards service details to a download server controller, which forms a response containing the corresponding service code and data using a User Account Manager and Storage Manager. The SSG then propagates this response to the client via the SSG, and awaits further client requests.

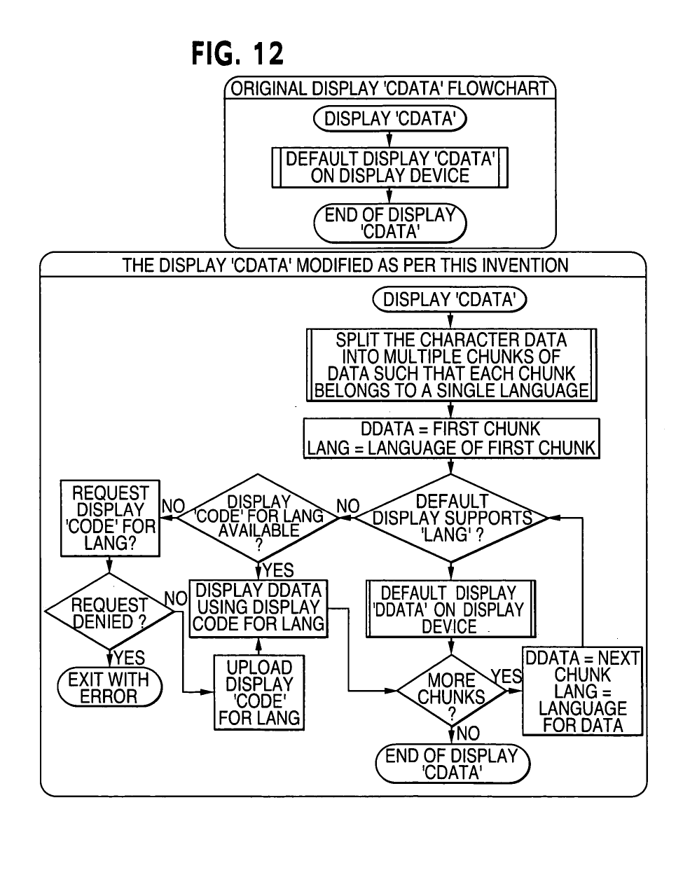

FIG. 12 is a flowchart illustrating a client-side multilingual display process. Each client is capable of displaying at least one font for at least one language. It may contain capability for multiple language fonts, one of which is designated as the default. In order to display text received in a different language, the client first parses the text to be displayed into chunks of data such that each chunk belongs to a single language. Text is transmitted in Unicode, which permits language identification. The client then forms a queue out of the chunks, labels the first such chunk as “ddata” and its corresponding language as “Lang”, and determines whether Lang is the default language. If so, the client proceeds to display that chunk and remove it from the queue. If the default display language is not compatible with the chunk under consideration, the process checks whether the associated display code is available on the user device, selects it if so, displays the chunk, and removes the chunk from the queue. If the user device does not have the required display code available, it sends a request to the AP, downloads and implements the appropriate display code, displays the chunk under consideration, and removes that chunk from the queue. After each chunk is removed from the queue, the process labels the next chunk in the queue (if any) as “ddata” and its corresponding language as “Lang”, and repeats until the queue is empty.

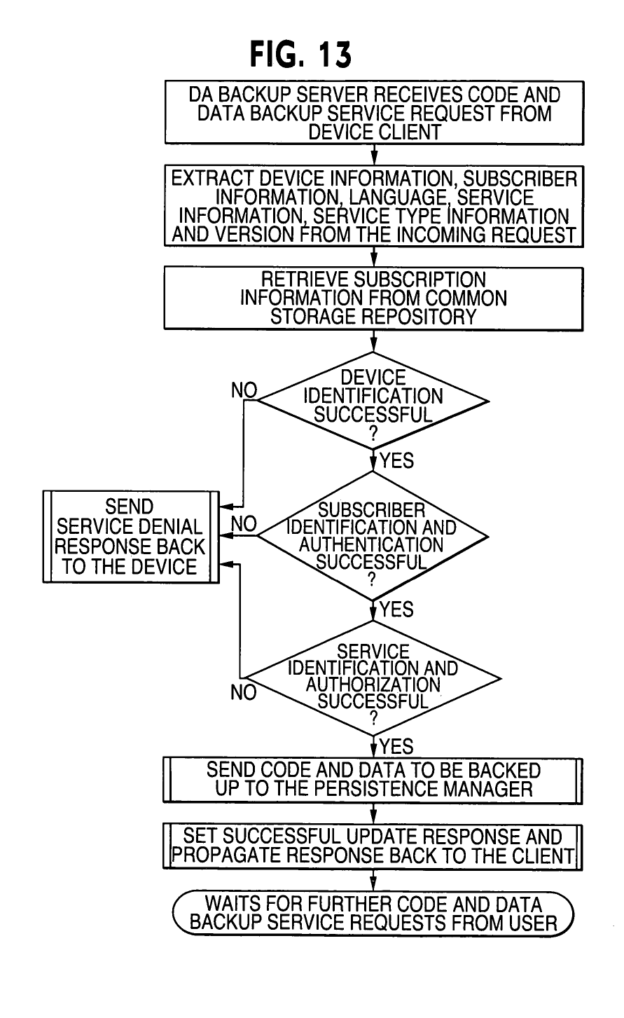

FIG. 13 is a flowchart illustrating AP storage of user device overflow code and data. If at any time the user device lacks memory to store desired code or data, it uploads the code and/or data that was least-recently used to the AP in order to free memory space. FIG. 13 describes this process. The process begins with the DA Backup Server of the AP receiving a code and data backup service request from a user device, and extracting therefrom device information, subscriber information, language, service information, service type information, and version parameters. The server the retrieves subscription information from the common storage repository and engages in AAA validation. Once validated, the server forwards the code and data to be backed up to the Persistence Manager, which stores this information. The server then forms a Successful Update response, propagates it to the client, and awaits further code and data backup requests.

FIG. 14 is a flowchart illustrating a server-side calculation for a client process. A client may use server processing power if it lacks sufficient resources to accomplish a task locally. Such a client passes a processing request to the SSC component of the SSG (see FIG. 2), which extracts device information, subscriber information, language, service information, service type information, and version parameters from the request. The server then activates AAA validation. Upon successful validation, the SSC sends the request through an Application Gateway to the appropriate Application Process Container, which hosts the requested service process. The requested service process acts on the requests and forms a response, which is sent via the Service Selection Controller to the requesting client. The Service Selection Controller proceeds to await further processing requests.

According to various embodiments of the present invention, the managers (e.g., USM, CSM, PM, BS, UIM, and LRM) may reside in diverse hardware and software components of the system. The managers may include processes distributed throughout the system, and are not necessarily resident on any single system portion. Further, both the AP and handset processes may be performed by the cooperation of multiple components.

It is noted that the foregoing examples have been provided merely for the purpose of explanation and are in no way to be construed as limiting of the present invention. While the present invention has been described with reference to certain embodiments, it is understood that the words which have been used herein are words of description and illustration, rather than words of limitation. Changes may be made, within the purview of the disclosure, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses.

What is claimed is:

1. A mobile telephony system, comprised of:
a plurality of mobile telephone devices, at least some mobile devices having differing amounts of data processing resources;
a first mobile application; and
a server in communication with said mobile telephone devices, said server and a first mobile device collectively performing said first mobile application, wherein the amount of data processing resources of the server utilized in the performance of the first mobile application is variably in accordance with the amount of data processing resources available at the first mobile device.

2. The mobile telephony system of claim 1, wherein said server is comprised of a user storage manager that allocates a data storage resource for each of a plurality of mobile devices.

3. The mobile telephony system of claim 1, wherein said server is comprised of a common storage manager that maintains a storage of data for each of a plurality of mobile devices.

4. The mobile telephony system of claim 1, wherein said server is comprised of a processor manager that allocates a computational resource to each of a plurality of mobile devices.

5. The mobile telephony system of claim 1, wherein a mobile device is comprised of a local resource manager that monitors an amount of data processing resources on said mobile device and communicates with said server.

6. The mobile telephony system of claim 1, wherein a mobile device is comprised of a bootstrap processor that initiates said first mobile application.

7. The system of claim 1, further including a second mobile application wherein said first mobile device suspends the first client application, uploads information about a state of the second mobile application to said server, and downloads information about a state of the second mobile application upon a request to perform the second mobile application.

8. The system of claim 1, wherein a mobile device and said serverjointly allocate resources to said first mobile application, thereby enabling the mobile device to perform mobile applications that exceed the data processing capabilities of the mobile device.

9. A mobile telephony application platform in communication with a plurality of mobile telephone devices, said mobile telephony application platform comprised of:
a user storage manager that allocates data storage resources at a fixed site to each of a plurality of mobile devices; and
a common storage manager that maintains storage for application data received from each of a plurality of mobile devices.

10. The mobile telephony application platform of claim 9 further comprising a processor manager that allocates a computational resource to process data for each of a plurality of mobile devices.

11. The mobile telephony application platform of claim 9 wherein a local resource manager on a mobile device communicates with said mobile telephony application platform, and wherein said mobile telephony application platform provides data processing resources for said mobile device, thereby enabling said mobile device to provide a mobile application that requires resources greater than available free resources of the mobile device.

12. The mobile telephony application of claim 9, wherein said mobile device is comprised of a bootstrap processor that initiates said mobile client application.

13. A mobile telephony system, comprised of:
(i) a first mobile application;
(ii) a mobile device, comprised of:
(a) a local resource manager that allocates a resource on said mobile device for said first mobile client application; and
(b) a bootstrap processor that initiates said first mobile client application; and an application platform, comprised of:
(iii) a user storage manager that allocates a resource on said application platform for said mobile device;
(iv) a common storage manager that maintains stateless data for said mobile device; and
(v) a processor manager that allocates a computational resource to said mobile device.

14. The system of claim 13, wherein said mobile device uploads information about a state of the first mobile client application to said application platform in order to make available resources for a second mobile application.

15. The system of claim 13, wherein said mobile device and said application platform jointly perform said mobile application, thereby enabling said first mobile application to exceed the resources of said mobile device.

16. A mobile telephony device comprising:
data processing resources capable of performing at least a part of a first mobile application; and
a bootstrap processor that initiates the mobile application in conjunction with a server that performs at least a part of the application using data processing resources at a location remote from the mobile device.

17. The mobile telephone device as in claim 16 capable of transmitting, to the remote location, information about a state of the first mobile application.

18. The mobile telephone device as in claim 16 capable of receiving, from the remote location, information about a state of a second mobile application.

19. The mobile telephone device as in claim 16 capable of:
transmitting, to the remote location, information about a state of the first mobile application in response to a request to perform a second mobile application;
receiving, from the remote location, information about a state of a second mobile application; and
initiating the second mobile application using the received state information.
